(19) United States
(12) Patent Application Publication
(10) Pub. No.: US 2011/0050905 A1
(43) Pub. Date: Mar. 3, 2011

(54) Target-Conforming Illuminator System

(75) Inventor: Glenn B. Slagle, McLean, VA (US)

(73) Assignee: UNITED STATES OF AMERICA, AS REPRESENTED BY THE SECRETARY OF THE ARMY, FORT BELVOIR, VA (US)

(21) Appl. No.: 12/547,690

(22) Filed: Aug. 26, 2009

(51) Int. Cl. H04N 5/30

(52) U.S. Cl. 348/162; 348/E05.09

(57) ABSTRACT

An illuminator comprises a thermal imager for generating a thermal image of a warm object, and a device for converting the thermal image to a visible light image and projecting and superimposing the visible light image back onto the object to illuminate the object with light that conforms to the outline of the object so that the object is easier to see in darkness.

### GOVERNMENT INTEREST

The invention described herein may be manufactured, used, sold, imported, and/or licensed by or for the Government of the United States of America.

### FIELD OF THE INVENTION

The invention relates to illumination devices for illuminating and identifying objects in darkness.

### BACKGROUND OF THE INVENTION

Prior art illuminators generally illuminate a fixed field of view that does not distinguish background and foreground scene clutter from military targets of interest such as people, vehicles, or animals. In cases of extreme clutter, the illumination may not improve object visibility at all, while providing ease of navigation and targeting for enemy personnel, vehicles and weapons.

### SUMMARY OF THE INVENTION

Accordingly, one object of the present invention is to provide illumination which conforms to the outline of specific warm objects of interest and does not illuminate cooler or non-moving background and foreground clutter, not of interest.

Another object of the invention is to enable many persons, such as, for example, the members of a rescue search party, to share the benefits of a thermal imager even though they are far removed from any imager display.

Yet another object of the invention is to illuminate unfriendly personnel, vehicular or other targets, while minimizing the enemy exploitability normally associated with conventional illuminators such as searchlights or flares.

These and other objects of the invention are achieved in one aspect by an illuminator. The illuminator comprises a thermal imager for generating a thermal image of a warm object, and means for converting the thermal image to a visible light image and projecting and superimposing the visible light image back onto the object to illuminate the object with light that conforms to the outline of the object so that the object is easier to see in darkness.

Another aspect of the invention involves an illuminating method comprising the steps of generating a thermal image of a warm object, converting the thermal image to a visible light image, and projecting and superimposing the visible light image back onto the object to illuminate the object with light that conforms to the outline of the object so that the object is easier to see in darkness.

Potential applications include improved battle space and a physical security illumination system that are less susceptible to enemy countermeasures. Other applications include improved air and ground-based search and rescue illumination, the reduction of light pollution, and possible less-blinding automobile headlights.

Additional advantages and features will become apparent as the subject invention becomes better understood by reference to the following detailed description when considered in conjunction with the accompanying drawings wherein:

### BRIEF DESCRIPTION OF THE DRAWINGS

FIG. 1 shows the invention as embodied in a typical search and rescue aircraft.

FIG. 2 shows another embodiment of the invention.

### DETAILED DESCRIPTION

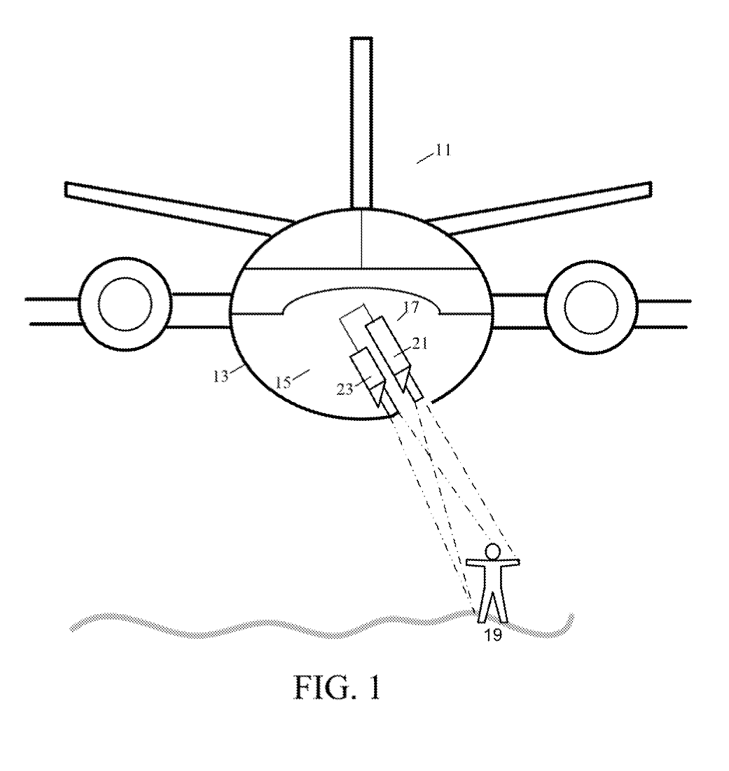

FIG. 1 shows the invention as embodied in a typical airborne search and rescue aircraft 11. The aircraft 11 includes a fuselage 13 having a cargo compartment 15. According to the invention, an illuminator 17 is placed in the open door of the cargo compartment 15 for illuminating and identifying warm objects 19 on the ground, such as a moving person or a moving vehicle, in the darkness.

The illuminator 17 includes a thermal imager 21, such as the Infrared Solutions model P200 LWIR 9-14u imager, and a visible light projection means 23 connected to the thermal imager. A thermal imager is a camera that takes pictures using the infrared portion of the electromagnetic spectrum. It is also known as a forward looking infrared (FLIR) system. While the visible light projection means 23 may take a variety of forms, conveniently it may take the form of a computer projector, such as the Epson company model EMP-61 projector, or a projection television, also the Epson company model EMP-61 (which accepts both television video as well as computer video inputs), collocated with the thermal imager 21 and oriented/equipped with compatible imager objective/projector optics, so that its field of view exactly matches that of the thermal imager.

In operation, an aircraft 11 on a search and rescue mission, circles a search area in the darkness and directs the thermal imager 21 at the ground. The thermal imager 21 generates thermal images of warm objects 19 of interest, and feeds them to the computer projector or projection television 23. The computer projector or projection television 23 converts the thermal images to visible light images, and projects and superimposes them onto the objects 19. The visible light images conform to the outlines of the objects 19 making them easier to see, while the cooler or non-moving background and foreground clutter remain dark.

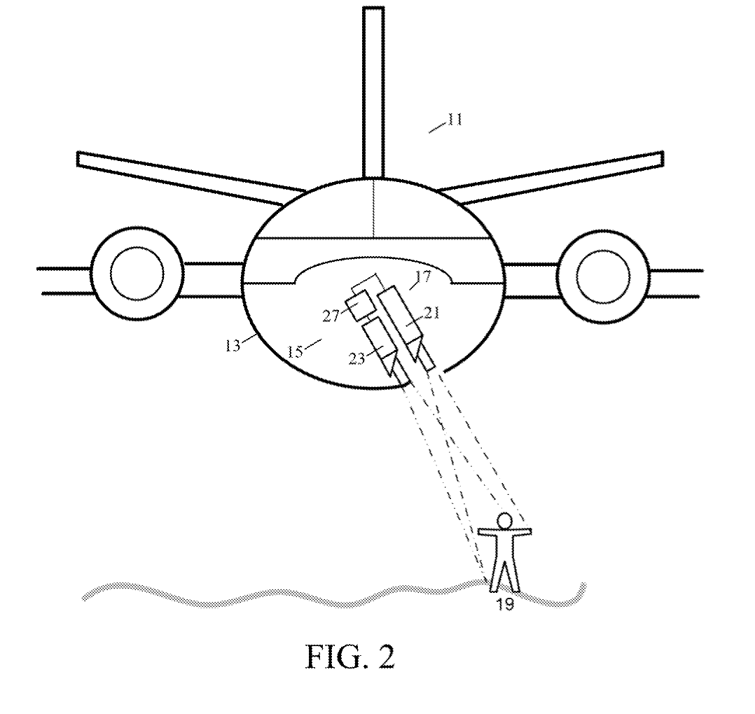

FIG. 2, wherein like reference numerals designate like or corresponding parts, shows another embodiment of the illuminator 17 which differs from the embodiment of FIG. 1 in that a means 27 is inserted to connect between the thermal imager 21 and the computer projector or projection television 23 for the purpose of conformal illumination of only moving objects. While a variety of such means may be used, conveniently it may take the form of a video motion detector, such as the Colorado Video company model 442, or a video scene subtractor, such as the Colorado Video company model 442 (in video scene subtraction mode).

It is obvious that many modifications and variations of the present invention are possible in light of the above teachings. For example, the illuminator could be placed in a trainable turret of an aircraft or helicopter. It is therefore to be understood that within the scope of the appended claims, the invention may be practiced otherwise than as described.

What is claimed is:

1. An illuminator comprising:
a thermal imager for generating a thermal image of a warm object; and
means for converting the thermal image to a visible light image and projecting and superimposing the visible light image back onto the object to illuminate the object with light that conforms to the outline of the object so that the object is easier to see in darkness.

2. The illuminator recited in claim 1 wherein the visible light projection means includes a computer projector.

3. The illuminator recited in claim 1 wherein the visible light projection means includes a projection television.

4. The illuminator recited in claim 1 including means inserted between the thermal imager and the visible light projection means for conformal illumination of only moving objects.

5. The illuminator recited in claim 4 wherein the moving object only illumination means includes a video motion detector.

6. The illuminator recited in claim 4 wherein the moving object only illumination means includes a video scene subtractor.

7. A target-conforming illuminator system comprising:
a thermal imager for generating a thermal image of a warm object;
a computer projector connected to the thermal imager for converting the thermal image to a visible light image and projecting and superimposing the visible light image back onto the object to illuminate the object with light that conforms to the outline of the object so that the object is easier to see in darkness; and
means connected between the thermal imager and the computer projector for conformal illumination of only moving objects.

8. The target-conforming illuminator system according to claim 7, wherein said system is installed in an aircraft to identify objects external to the aircraft.

9. The target-conforming illuminator system according to claim 7, wherein said moving objects are warm ground objects.

10. An illuminating method comprising the steps of:
generating a thermal image of a warm object;
converting the thermal image to a visible light image; and
projecting and superimposing the visible light image back onto the object to illuminate the object with light that conforms to the outline of the object, so that the object is easier to see in darkness.

11. The illuminating method according to claim 10, wherein said method is employed in an aircraft target-conforming illuminator system to identify an object external to the aircraft.

12. The illuminating method according to claim 10, wherein said warm object is a ground object.
